(19) United States
(12) Patent Application Publication
(10) Pub. No.: US 2007/0160730 A1
(43) Pub. Date: Jul. 12, 2007

(54) Use of Decalepis hamiltonii in flavor compositions

(76) Inventors: Thumpalasseril V. John, Morganville, NJ (US); Muthusamy Gunasekar, (US); Garry Conklin, Pequannock, NJ (US); Mark Lawrence Dewis, Matawan, NJ (US)

Correspondence Address: INTERNATIONAL FLAVORS & FRAGRANCES INC., 521 WEST 57TH ST, NEW YORK, NY, 10019, US

(21) Appl. No.: 11/329,006

(22) Filed: Jan. 10, 2006

(51) Int. Cl. A23L 1/22

(52) U.S. Cl. 426/534

(57) ABSTRACT

The use of Decalipis hamiltonii or 2-hydroxy-4-methoxy benzaldehyde for use in combination with vanilla for flavoring foodstuffs is disclosed.

### FIELD OF THE INVENTION

The use of Decalipis hamiltonii extract and constituent chemicals are disclosed as flavor chemicals suitable for incorporation in food products, most preferably when used in combination with vanilla and related applications.

### BACKGROUND OF THE INVENTION

Vanilla is one of the most common flavors used in commerce throughout the world. As a natural material, vanilla prices can be subject to major price swings due to supply and demand and the inherent uncertainty associated with crops. The price of vanilla can greatly vary due to numerous factors which influence crops yields such as insect damage, adverse weather conditions and plant diseases.

The flavor of natural vanilla extract is due to the numerous aromatic compounds produced during curing and extraction, among which vanillin is the most abundant. The other major vanillin phenolics that are responsible for the flavor are believed to be p-hydroxy benzaldehyde, p-hydroxy benzoic acid and vanillic acid. Besides these major phenolics there are large numbers of other flavor compounds that are responsible for the complex nature of natural vanilla extract/oleoresin flavor (Ref. Purseglove, J. W. et al; Vanilla, Chapter 2 in book Spices Volume 2, Longman Scientific and Technical; Harlow, U. K. 1988; 644-735)

In view of the very complex nature of the natural vanilla extract, it is very difficult to create natural vanilla extract replacement or extender materials without employing a natural vanilla extract.

There is an ongoing need to develop new materials that can be used to enhance or extend vanilla flavor while maintaining vanilla's desirable characteristics.

### SUMMARY OF THE INVENTION

In a first embodiment, the present invention provides an organoleptically acceptable amount of Decalipis hamiltonii extraction to provide a vanilla flavor to a food product. In a second embodiment the invention provides an organoleptically acceptable amount of 2-hydroxy-4-methoxy benzaldehyde to provide a vanilla flavor to a food product. In a third embodiment of the invention provides an organoleptically acceptable combination of vanilla and Decalipis hamiltonii extract. In another embodiment, the present invention provides the use of in an organoleptically effective amount of Decalipis hamiltonii, preferably in combination with vanilla flavoring in food products to enhance the flavor of the food.

The present invention also contemplates the use of 2-hydroxy-4-methoxy benzaldehyde to provide a vanilla flavor in foodstuff as well as in combination with vanilla in a flavor package.

In another embodiment the present inventions employs Decalipis hamiltonii extract or 2-hydroxy-4-methoxy benzaldehyde to mask the undesirable taste notes of foods such soy-containing products.

These and other embodiments of the present invention will be apparent by reading the following specification.

### DETAILED DESCRIPTION OF THE INVENTION

We have discovered that the use of Decalipis hamiltonii extract and/or 2-hydroxy-4-methoxy benzaldehyde has the ability to provide a vanilla flavor to foodstuffs, or to enhance or extend the taste of vanilla. Therefore Decalipis hamiltonii extract and/or 2-hydroxy-4-methoxy benzaldehyde can be used advantageously in combination to vanilla to economically enhance the desirable taste of vanilla.

Decalipis hamiltonii is a native Indian plant whose roots are grown commercially and available. Decalipis hamiltonii roots are preferably employed in the present invention to make the extract. The roots should have a moisture content of from about 1 to about 95 weight %, more preferably from about 5 to about 10 weight %. The Decalipis hamiltonii roots should be reduced in size, and in a preferred mode are coarsely powdered before addition to the extractor. To make the desired extract, the Decalipis hamiltonii roots are charged into an extractor, with the desired food-grade solvent. The solvent can be polar such as ethyl alcohol or water or a non-polar solvent such as hexane. In a preferred embodiment ethyl alcohol, is added at a solvent/Decalipis hamiltonii root ratio of between about 10 to about 1, preferably from about 3:1 on weight basis. The temperature of the solvent is maintained between about room temperature, about 22° C., to about 82° C.; preferably between about 40 and about 80° C. To obtain higher yields of the extract, the solvent should be continuously circulated in the extractor for period of from about 1 to about 48 hours preferably about 4 to about 8 hours. At the end of the extraction time, the heating is stopped and the extract is drained and stored. The extraction is repeated for another 1 to 6 times preferably 2 to 3 times. The extracts are then combined, filtered if required, and concentrated. The concentration is done under a vacuum of 1 to 760 Torr and a temperature from room temperature to 80 C preferably at a vacuum from 100 to 300 Torr and a temperature from 40 to 70° C. When part of the ethyl alcohol is removed, propylene glycol can be added at a level of 1 to 25 weight %, preferably 2 to 10% of the original weight of the roots and then concentration of the extract is continued until required level of ethanol is reached. The extract also can be prepared without the addition of the propylene glycol.

As used herein flavor effective amount or organoleptically effective amount is understood to mean the amount of compound in flavor compositions the individual component will contribute to its particular organoleptic characteristics. The flavor effect of the flavor composition will be the sum of the effects of each of the flavor ingredients. Thus the compounds of the invention can be used to alter the taste characteristics of the flavor composition by modifying the taste reaction contributed by another ingredient in the composition. The amount will vary depending on many factors including other ingredients, their relative amounts and the effect that is desired.

The level of Decalipis hamiltonii extract used in flavor compositions is greater than 0.1 parts per million, generally provided at a level of from about 0.5 to about 50 parts per million in the finished food product, more preferably from about 1 parts per to about 10 parts per million. The Decalipis hamiltonii extract has been found to enhance the flavors at levels greater than about 0.25 parts per million, including uses to enhance the flavor of soy products such as soy milk, soy protein or soy protein extract at levels as as about 0.5 to about 10 parts per million by weight.

Another way of reporting the level of Decalipis hamiltonii extract is to report it as a weight ratio in combination with vanilla. The weight ratio of vanilla to Decalipis hamiltonii extract is from about 1:1 to about 1:100, preferably from about 10:1 to about 25:1 and most preferably at a ratio of about 25:1 in a foodstuff.

Through the work leading to this invention we have discovered that Decalipis hamiltonii extract is about 100 fold stronger in providing a vanilla flavor than vanilla extract. Other investigations have led us to quantify Decalipis hamiltonii extract as having 10 fold strength in comparison to a 20 fold vanilla bourbon concentrate.

Further investigation of the Decalipis hamiltonii extract lead to the discovery that the desirable flavor component of the extract was provided by 2-hydroxy-4-methoxy benzaldehyde. We have discovered that 2-hydroxy-4-methoxy benzaldehyde is present in Decalipis hamiltonii extract at a level of from about 2 to about 3.5 weight percent. In some circumstances it may be more desirable from a taste or cost standpoint to use 2-hydroxy-4-methoxy benzaldehyde to extend the vanilla flavor. 2-hydroxy-4-methoxy benzaldehyde is available from various sources including Aldrich Chemicals.

In a preferred embodiment the level of 2-hydroxy-4-methoxy benzaldehyde used is about at a level of greater than about 0.1 ppm, preferably from about 1 to about 5 parts per million by weight to provide a vanilla flavor. Alternatively it can be used at a level of from about 2 to 5 weight percent of the extract level to extend the vanilla flavor.

Another way of reporting the level of 2-hydroxy-4-methoxy benzaldehyde level is to report it as a weight ratio in combination with vanilla. The weight ratio of vanilla to 2-hydroxy-4-methoxy benzaldehyde is from about 50:1 to about 20:1, most preferably at a level of from 25:1 on a weight by weight basis.

The present invention also provides for the use of both Decalipis hamiltonii extract and 2-hydroxy-4-methoxy benzaldehyde to enhance the vanilla flavor in a foodstuff.

The term “foodstuff” as used herein includes both solid and liquid ingestible materials for consumption by man or animals, which materials usually do, but need not, have nutritional value. Thus, foodstuffs include meats, gravies, soups, convenience foods, malt, alcoholic and other beverages, milk, yogurt, ice cream and other dairy products, confectionary products, chocolate-containing products, beverages, seafood products, including fish, crustaceans, mollusks and the like, candies, vegetables, cereals, soft drinks, snacks, dog and cat foods, other veterinary products and the like.

When the compounds of this invention are used in a flavoring composition, they can be combined with conventional flavoring materials or adjuvants. Such co-ingredients or flavor adjuvants are well known in the art for such use and have been extensively described in the literature. Requirements of such adjuvant materials are: (1) that they be non-reactive with the 2-hydroxy-4-methoxy benzaldehyde of our invention; (2) that they be organoleptically compatible with the 2-hydroxy-4-methoxy benzaldehyde derivative(s) of our invention whereby the flavor of the ultimate consumable material to which the 2-hydroxy-4-methoxy benzaldehyde are added is not detrimentally affected by the use of the adjuvant; and (3) that they be ingestibly acceptable and thus nontoxic or otherwise non-deleterious. Apart from these requirements, conventional materials can be used and broadly include other flavor materials, vehicles, stabilizers, thickeners, surface active agents, conditioners and flavor intensifiers.

Such conventional flavoring materials include saturated fatty acids, unsaturated fatty acids and amino acids; alcohols including primary and secondary alcohols, esters, carbonyl compounds including ketones (other than the 2-hydroxy-4-methoxy benzaldehyde derivatives of our invention) and aldehydes; lactones; other cyclic organic materials including benzene derivatives, alicyclic compounds, heterocyclics such as furans, pyridines, pyrazines and the like; sulfur-containing compounds including thiols, sulfides, disulfides and the like; proteins; lipids, carbohydrates; so-called flavor potentiators such as monosodium glutamate; magnesium glutamate, calcium glutamate, guanylates and inosinates; natural flavoring materials such as cocoa, vanilla and caramel; essential oils and extracts such as anise oil, clove oil and the like and artificial flavoring materials such as vanillin, ethyl vanillin and the like.

Specific preferred flavor adjuvants include but are not limited to the following: anise oil; ethyl-2-methyl butyrate; vanillin; cis-3-heptenol; cis-3-hexenol; trans-2-heptenal; butyl valerate; 2,3-diethyl pyrazine; methyl cyclo-pentenolone; benzaldehyde; valerian oil; 3,4-dimeth-oxyphenol; amyl acetate; amyl cinnamate; γ-butyryl lactone; furfural; trimethyl pyrazine; phenyl acetic acid; isovaleraldehyde; ethyl maltol; ethyl vanilin; ethyl valerate; ethyl butyrate; cocoa extract; coffee extract; peppermint oil; spearmint oil; clove oil; anethol; cardamom oil; wintergreen oil; cinnamic aldehyde; ethyl-2-methyl valerate; γ-hexenyl lactone; 2,4-decadienal; 2,4-heptadienal; methyl thiazole alcohol (4-methyl-5-β-hydroxyehtyl thiazole); 2-methyl butanethiol; 4-mercapto-2-butanone; 3-mercapto-2-pentanone; 1-mercapto-2-propane; benzaldehyde; furfural; furfuryl alcohol; 2-mercapto propionic acid; alkyl pyrazine; methyl pyrazine; 2-ethyl-3-methyl pyrazine; tetramethyl pyrazine; polysulfides; dipropyl disulfide; methyl benzyl disulfide; alkyl thiophene; 2,3-dimethyl thiophene; 5-methyl furfural; acetyl furan; 2,4-decadienal; guiacol; phenyl acetaldehyde; β-decalactone; d-limonene; acetoin; amyl acetate; maltol; ethyl butyrate; levulinic acid; piperonal; ethyl acetate; n-octanal; n-pentanal; n-hexanal; diacetyl; monosodium gulatamate; monopotassium glutamate; sulfur-containing amino acids, e.g., cysteine; hydrolyzed vegetable protein; 2-methylfuran-3-thiol;2-methyldihydrofuran-3-thiol; 2,5-dimethylfuran-3-thiol; hydrolyzed fish protein; tetramethyl pyrazine; propylpropenyl disulfide; propylpropenyl trisulfide; diallyl disulfide; diallyl trisulfide; dipropenyl disulfide; dipropenyl trisulfide; 4-methyl-2-[(methylthio)-ethyl)-1,3-dithiolane; 4,5-dimethyl-2-(methylthiomethyl)-1,3-dithiolane; and 4-methyl-2-(methylthiomethyl)-1,3-dithiolane. These and other flavor ingredients are provided in U.S. Pat. Nos. 6,110,520 and 6,333,180 hereby incorporated by reference.

The method of our invention or compositions incorporating them, as mentioned above, can be combined with one or more vehicles or carriers for adding them to the particular product. Vehicles can be edible or otherwise suitable materials such as ethyl alcohol, propylene glycol, water and the like, as described supra. Carriers include materials such as gum arabic, carrageenan, xanthan gum, guar gum and the like.

The flavors of the present invention can be incorporated with the carriers by conventional means such as spray-drying, drum-drying and the like. Such carriers can also include materials for coacervating the 2-hydroxy-4-methoxy benzaldehyde of our invention to provide encapsulated products, as set forth supra. When the carrier is an emulsion, the flavoring composition can also contain emulsifiers such as mono- and diglycerides or fatty acids and the like. With these carriers or vehicles, the desired physical form of the compositions can be prepared.

The quantity of derivative(s) utilized should be sufficient to impart the desired flavor characteristic to the product, but on the other hand, the use of an excessive amount of Decalipis hamiltonii, Decalipis hamiltonii extract or 2-hydroxy-4-methoxy benzaldehyde is not only wasteful and uneconomical, but in some instances, too large a quantity may unbalance the flavor or other organoleptic properties of the product consumed. The quantity used will vary depending upon the ultimate foodstuff; the amount and type of flavor initially present in the foodstuff; the further process or treatment steps to which the foodstuff will be subjected; regional and other preference factors; the type of storage, if any, to which the product will be subjected; and the pre-consumption treatment such as baking, frying and so on, given to the product by the ultimate consumer. Accordingly, the terminology “effective amount” and “sufficient amount” is understood in the context of the present invention to be quantitatively adequate to alter the flavor of the foodstuff. The term “organoleptically acceptable” is understood mean a level of the flavoring agents which impart an acceptable flavor to a foodstuff or other product.

The following are provided as specific embodiments of the present invention. Other modifications of this invention will be readily apparent to those skilled in the art, without departing from the scope of this invention. As used herein, both specification and following examples all percentages are weight percent unless noted to the contrary. All US Patents and patent applications referenced herein are hereby incorporated by reference as if set forth in their entirety.

### EXAMPLE 1

A test was conducted to evaluate the effectiveness of Decalipis hamiltonii extract in providing a vanilla flavor to products. The tests were conducted using a full fat vanilla yogurt containing 9 weight percent sugar.

Three Products were Compared:

1) a vanilla extract (5 fold), used as 2 weight percent in propylene glycol, used at 0.5 weight percent in a 0.5 weight percent in 3 weight % sugar solution;
2) a vanilla concentrate (25 fold) used as a 1 weight percent solution in propylene glycol at a level of 0.8 level in a 3 weight percent solution; and
3) a Decalipis hamiltonii extract was used as 0.1 weight percent level in propylene glycol and used as a 0.5 level in a 3% sugar solution.

The tests were conducted 3 days after preparation of the samples. A triangle test, with a forced choice between the samples was employed. Three samples were presented to panelists, two were the same. The thirty-six (36) panelists were then required to determine the sample that is different from the other two. Then, the panelists were asked to comment on the nature of the difference perceived between the odd and the two other samples. The presentation was balanced over six possible combinations and randomized over the whole group of panelists in order to get statistically significant results. Significance level to be determined at an a risk of 5% (Probability p<0.05)

Results:

| | | (Required | |
|---|---|---|---|
| | N of | for sign. | |
| N of | Correct | At P = 0.05) | Significance |
| Subjects | responses | P value | in this test: |
| 36 | 14 | 18 | Not |
| | | | significant |

Conclusion:

At 95% confidence level, the flavor samples were not perceived as different, indicating that Decalipis hamiltonii extract could be used.

### EXAMPLE 2

In an experiment similar to one conducted above, a vanilla flavoring concentrate (25 fold) at 2 weight was compared to a 2 weight % concentrate at a level of 0.2% of Decalipis hamiltonii extract in the formula. The triangle test format was used again and panelist group (4 panelists) could not identify the difference in flavor.

The testing conducted here was conducted at a flavor level that is approximately 10 fold increase over the flavor or concentration of a common flavor.

### EXAMPLE 3

Decalipis hamiltonii roots with a moisture content of about 8±2% was coarsely powdered and charged into an extractor. Ethyl alcohol was added at a ratio of 2:1 on weight basis. The temperature of the solvent was maintained at 80±2° C. and the hot solvent was continuously circulated for a period of about 6 hours. At the end of 6 hours, heating was stopped and the extract was drained, filtered and stored. The extraction was repeated twice more following the above conditions except for the solvent to root original weight ratio. The ratio for the second and third extraction was maintained at 1.5:1 and 1:1 respectively.

The above 3 extracts were then combined and concentrated under vacuum (50-55° C. and 180 to 200 Torr) to 50% of its original weight. Propylene glycol was then added (4% of the original weight of the Decalipis hamiltonii roots) and then concentration of the extract was continued until the ethyl alcohol was completely removed (25 to 50 PPM ethyl alcohol in the concentrated extract).

The concentrated extract was then analyzed for its actives. The level of the flavor marker chemical, 2-hydroxy-4-methoxy benzaldehyde was adjusted to 2.7±0.3% by adjusting the level of Propylene Glycol. Vanillin content of the extract was normally at 0.25±0.05%.

### EXAMPLE 4

A typical high fat ice cream was prepared with one of three flavor systems. The first flavor was a standard category one vanilla flavor composed of a blend of vanilla extracts. This flavor was added to the ice cream at 1%. The second set of ice cream was flavored only with Decalipis hamiltonii extract at 50 ppm. The third ice cream was flavored with 0.5% of vanilla flavor with 25 ppm of Decalipis hamiltonii

These three ice creams were then given to a trained panel of flavorists and food technologists and ask to rate the samples for hedonic liking and vanilla intensity. The preferred sample was the ice cream containing the blend of vanilla extract and Decalipis hamiltonii. The ice cream containing the blend of vanilla extracts and Decalipis hamiltonii was considered to be stronger in vanilla profile and was considered the most creamy of the samples.

### EXAMPLE 5

An imitation vanilla extract was prepared using Decalipis hamiltonii extract and natural vanillin obtained from lignin. This preparation was compared to commercially available imitation vanilla extract. The two extracts were compared to a standard single fold vanilla extract in sugar water and in sweetened milk. The imitation vanilla extract containing the Decalipis hamiltonii extract was considered to be closer in flavor profile to the pure vanilla extract, with more of the pruney, beany character of the vanilla extract than was present in the commercially available artificial vanilla extract.

### EXAMPLE 6

A commercially available unflavored soymilk was flavored with either pure vanilla extract at 0.5% or with a blend of Decalipis hamiltonii extract at 100 ppm and vanilla extracts 0.25%. A panel of flavorists and food technologists were given the two samples and ask to hedonically rate them for liking as well as to describe the level of off-notes typically described in soymilks, such as the notes typically referred to as “beany”, astringent, or bitter. The panel preferred the soymilk flavored with the blend of vanilla extract and Decalipis hamiltonii and found that this sample had less of the soy “beany” taste.

### EXAMPLE 7

Sugar cookies were prepared according to a standard formulation. To one batch of cookies a typical vanilla extract was added, to another vanillin was used in place of the vanilla extract. A third batch of cookies were flavored using only Decalipis hamiltonii extract. The three batches of cookies were then baked at 350 degrees for 15 minutes.

The baked cookies were given to a trained panel for evaluation and asked to rate for hedonic liking, vanilla intensity and profile. The panel found the cookies flavored with Decalipis hamiltonii to have the most intensive vanilla profile, and slightly preferred these cookies over the cookies prepared with the vanilla extract. The cookies made with the vanillin only were judged to be the least flavorful of the samples, with little vanilla taste.

What is claimed is:

1. A method for improving, enhancing or modifying the vanilla flavor of a foodstuff through the addition of an organoleptically acceptable amount of 2-hydroxy-4-methoxy benzaldehyde.

2. The method of claim 1 wherein the level of 2-hydroxy-4-methoxy benzaldehyde is greater than about 0.1 parts per million.

3. The method of claim 1 wherein the level of 2-hydroxy-4-methoxy benzaldehyde is from about 1 to about 5 parts per million.

4. The method of claim 2 wherein the flavor is incorporated into a foodstuff selected from soy containing products, milk and dairy products, candies, cereals, chocolate containing products, soft drinks and snacks.

5. The method of claim 4 wherein the level of 2-hydroxy-4-methoxy benzaldehyde is greater than about 100 parts per trillion by weight in the food product.

6. The method of claim 2 which additionally contains vanilla.

7. The method of claim 6 wherein the weight ratio of vanilla to 2-hydroxy-4-methoxy benzaldehyde is from about 50:1 to about 20:1.

8. A foodstuff comprising in combination vanilla and an organoleptically acceptable amount of 2-hydroxy-4-methoxy benzaldehyde.

9. The combination of claim 8 wherein the level of 2-hydroxy-4-methoxy benzaldehyde is greater than about 0.1 parts per million by weight in the foodstuff.

10. The combination of claim 10 wherein the level of 2-hydroxy-4-methoxy benzaldehyde is from about 1 to about 5 parts per million by weight.

11. The combination of claim 11 which is incorporated into a beverage.

12. A method for improving, enhancing or modifying the vanilla flavor of a foodstuff through the addition of an organoleptically acceptable amount of Decalipis hamiltonii extract.

13. The method of claim 12 wherein the level of Decalipis hamiltonii extract is greater than about 0.1 parts per million.

14. The method of claim 13 wherein the level of Decalipis hamiltonii extract is from about 0.5 to about 50 parts per million.

15. The method of claim 13 wherein the flavor is incorporated into a foodstuff selected from the group consisting of soy containing products, milk and dairy products, candies, cereals, soft drinks, chocolate containing products and snacks.

16. A foodstuff containing in combination vanilla and an organoleptically acceptable amount of Decalipis hamiltonii.

17. The foodstuff of claim 16 wherein the level of Decalipis hamiltonii extract is greater than about 0.1 parts per million by weight in the foodstuff.

18. The foodstuff of claim 16 wherein the level of Decalipis hamiltonii is from about 0.5 to about 50 parts per million by weight in the foodstuff.

19. The combination of claim 16 which is incorporated into a beverage.

20. A method of reducing the bitter flavor of a soy-containing product comprising adding an organoleptically effective level of a material selected from the group consisting of 2-hydroxy-4-methoxy benzaldehyde and Decalipis hamiltonii extract.

21. The method of claim 21 wherein the level of 2-hydroxy-4-methoxy benzaldehyde and Decalipis hamiltonii extract is greater than about 0.1 parts per million by weight in the soy-containing product.
